(19) United States
(12) Patent Application Publication
(10) Pub. No.: US 2003/0061291 A1
(43) Pub. Date: Mar. 27, 2003

(54) Electronic mail relay apparatus, method of preventing reception of junk mail, and computer product

(75) Inventor: Koichi Takahashi, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/080,622

(22) Filed: Feb. 25, 2002

(30) Foreign Application Priority Data
Sep. 26, 2001 (JP) 2001-294321

(51) Int. Cl. G06F 15/16

(52) U.S. Cl. 709/206

(57) ABSTRACT

The electronic mail relay apparatuses relay electronic mails from the transmitting terminal to the receiving terminal. The recipient determines whether a received mail is a junk mail or not. If the mail is a junk mail, the recipient sends a warning notice with respect to the transmitter. If the recipient sends the warning notice a second time, then a penalty invoice notice is issued with respect to that particular transmitter.

### FIELD OF THE INVENTION

The present invention relates to a technology for preventing transmission of junk mail and the electronic mail relay apparatus which can prevent indiscriminate transmission of junk advertisement mails by an advertising agency.

### BACKGROUND OF THE INVENTION

Recently, with the proliferation of the Internet and mobile communication networks, there has been an enormous increase in the ownership of computer terminals, portable terminals (mobile telephone terminals, PHS {Personal Handy Phone System} terminals) and the like wherein electronic transmitting/receiving is possible, and electronic mail has become a conventional form of communication.

Electronic mail is used not only as a communication tool but also as a direct advertising medium by agencies. The agencies obtain IP addresses (electronic mail addresses) of advertising targets by various methods, and transmit mass electronic mails containing advertisements and publicity to these IP addresses.

Two types of electronic mails, i.e. optin mail and spam mail, are used in advertising. Optin mail is sent after receiving a permission from the target. On the other hand, spam mail is transmitted without obtaining permission in this way.

Thus, the advertising agency transmits the spam mails without considering the wills of the recipients. Sometimes such mail may be useful to the recipient. However, most of the time this type of spam mail is extremely bothersome and unpleasant, and therefore called as a junk mail. In addition to suffering unpleasant emotional distress and the like, the recipient is burdened with the financial expense of receiving the mail.

Since junk mail has become a social problem, agencies such as communication companies and internet providers have recently implemented a variety of countermeasures which prevents junk mail. Nevertheless, the reality is that they have had little effect.

For an example of the countermeasures, requests to cease sending junk mail have been made in an attempt to appeal to the morals of unscrupulous agencies who send mass junk mail. Such countermeasures have absolutely no effect.

### SUMMARY OF THE INVENTION

It is an object of this invention to provide a method, an electronic mail relay apparatus, and a computer program which can prevent transmission of junk mail.

The method of preventing transmission of junk mail according to one aspect of the present invention comprises relaying an electronic mail from a transmitter to a recipient, sending a warning notice to the transmitter, when the recipient determines that the received electronic mail is a junk mail and sends a reception refusal notice, and issuing a penalty invoice notice to the transmitter, when the recipient sends the reception refusal notice for a particular number of times with respect to the same transmitter.

The electronic mail relay apparatus according to another aspect of the present invention comprises a relay unit which relays an electronic mail from an electronic mail address of a transmitter to an electronic mail address of a receiver, a warning notice unit which sends a warning notice to the transmitter, when the recipient determines that the received electronic mail is a junk mail and sends a reception refusal notice, and a penalty invoice notification unit which issues a penalty invoice notice with respect to the electronic address of the transmitter, when the recipient sends the reception refusal notice for a particular number of times with respect to the same transmitter.

The computer program according to still another aspect of the present invention realizes all the units in the electronic mail relay apparatus according to the present invention on a computer.

Other objects and features of this invention will become apparent from the following description with reference to the accompanying drawings.

### BRIEF DESCRIPTION OF THE DRAWINGS

FIG. 1 is a block diagram which shows the constitution of an embodiment of the present invention,

FIG. 2 is a diagram which shows an electronic mail format F1 in the same embodiment,

FIG. 3 is a diagram which shows the relationship between mail classification and lump fees in the same embodiment,

FIG. 4 is a block diagram which shows the constitution of a transmitting terminal 100A shown in FIG. 1,

FIG. 5 is a block diagram which shows the constitution of a receiving terminal 100B shown in FIG. 1,

FIG. 6 is a block diagram which shows the constitution of the electronic mail relay apparatus 400A shown in FIG. 1,

FIG. 7 is a block diagram which shows the constitution of the electronic mail relay apparatus 400B shown in FIG. 1,

FIG. 8 shows fee management information databases 410A and 410B of FIG. 6 and FIG. 7,

FIG. 9 is a diagram which shows the table constitution of a junk mail management information database 420B shown in FIG. 7,

FIG. 10 is a flowchart which shows the operation of the transmitting terminal 101A shown in FIG. 1,

FIG. 11 is a flowchart which shows the operation of the receiving terminal 100B shown in FIG. 1,

FIG. 12 is a flowchart which shows the operation of the electronic mail relay apparatus 400A shown in FIG. 1,

FIG. 13 is a flowchart which shows the warning/penalty invoice mail transmission processing shown in FIG. 12,

FIG. 14 is a flowchart which shows the warning mail transmission processing shown in FIG. 13,

FIG. 15 is a flowchart which shows penalty invoice mail transmission processing shown in FIG. 13,

FIG. 16 is a flowchart which shows the operation of the electronic mail relay apparatus 400B shown in FIG. 1,

FIG. 17 is a flowchart which shows the warning request/penalty invoice request mail transmission processing shown in FIG. 16,

FIG. 18 is a diagram which shows mail and screen changes in the same embodiment,

FIG. 19 is a diagram which shows mail and screen changes in the same embodiment,

FIG. 20 is a diagram which shows an electronic mail format F2 in the same embodiment,

FIG. 21 is a diagram which shows mail classification and lump fees in the same embodiment,

FIG. 22 is a diagram which shows another table constitution of the junk mail management information database 420B shown in FIG. 1, and

FIG. 23 is a block diagram which shows the constitution of a modification of the same embodiment.

### DETAILED DESCRIPTIONS

Embodiments of the method of preventing transmission of junk mail, the electronic mail relay apparatus, and the computer program according to this invention will be explained with reference to the accompanying drawings.

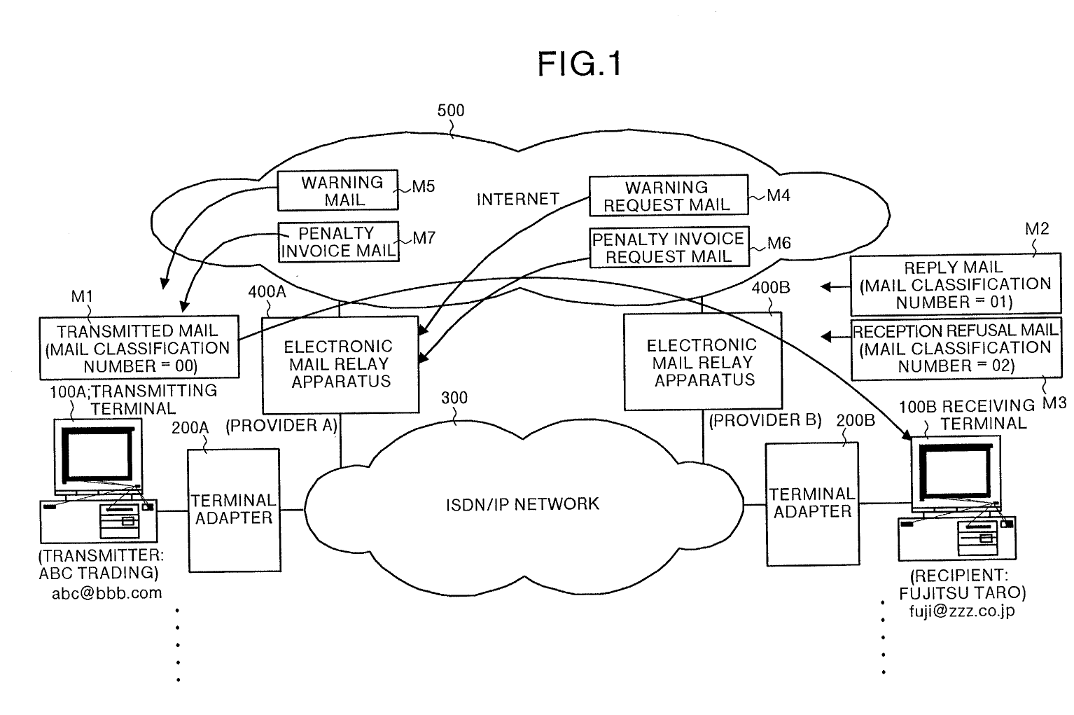

FIG. 1 is a block diagram showing the constitution of an embodiment of this invention. As shown in FIG. 1, a junk mail prevention system comprises a transmitting terminal 100A, a terminal adapter 200A, an electronic mail relay apparatus 400A, and electronic mail relay apparatus 400B, a terminal adapter 200B, a receiving terminal 100B, and the like.

The junk mail prevention system prevents agencies from retransmitting one-way junk mail to advertising targets. The junk mail prevention system mainly uses a total of seven types of electronic mail, comprising transmitted mail M1, receive mail M2, reception refusal mail M3, warning request mail M4, warning mail M5, penalty invoice request mail M6, and penalty invoice mail M7.

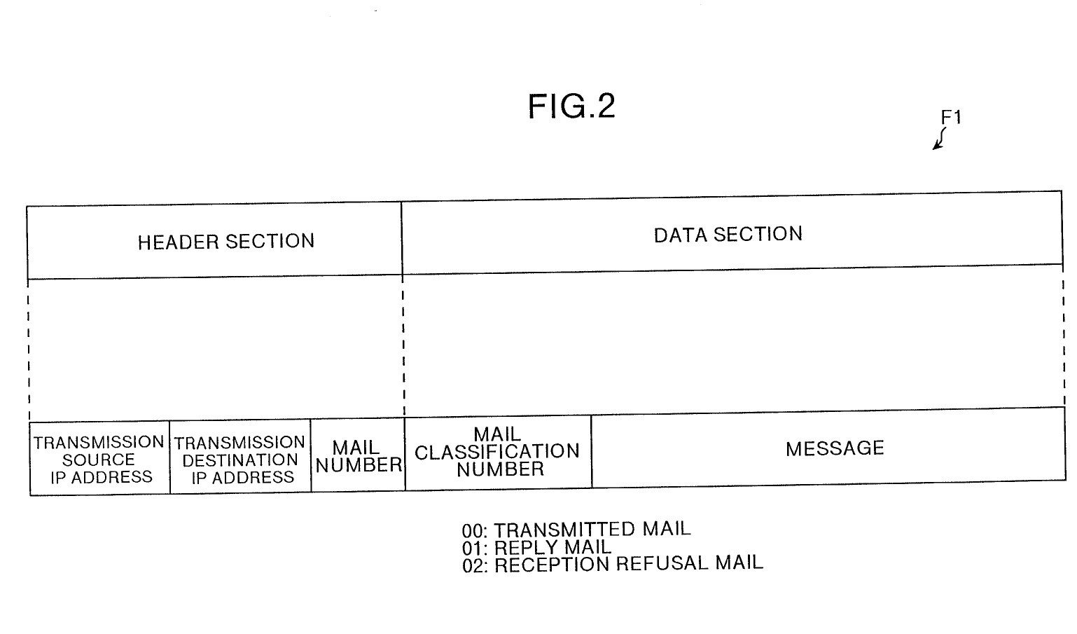

These electronic mails are created based on a format F1 shown in FIG. 2. The format F1 has a head section and a data section. The head section comprises a transmission source IP address (electronic mail address), a transmission destination IP address, and a mail number. The IP address is actually expressed by four numbers partitioned at every eighth bit, such as “202.247.130.5”. However, to simplify the explanation in the first embodiment, the IP address is expressed in letters as a domain name such as “abc@bbb.com”.

The transmission source IP address is an IP address which identifies the source which an electronic mail was transmitted from. The transmission destination IP address identifies the transmission destination of the electronic mail. The mail number is a number which identifies the electronic mail.

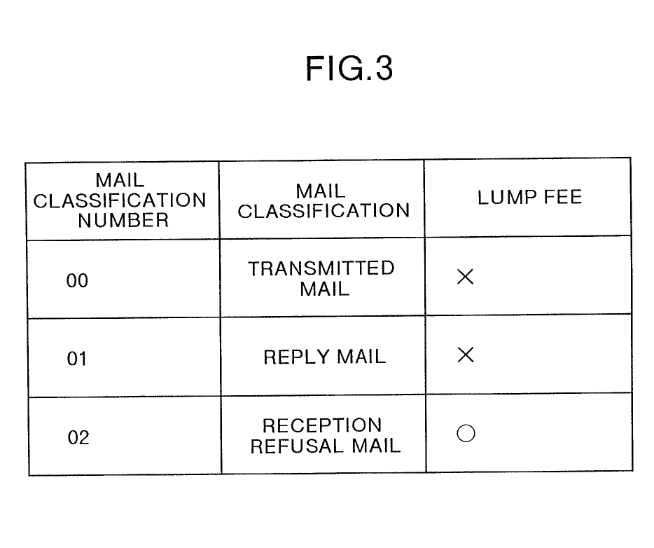

The data section comprises a mail classification number and a message. The mail classification number corresponds to the classification (transmitted mail M1, receive mail M2, reception refusal mail M3) of the electronic mail. The mail classification number 00 corresponds to a transmitted mail M1 which is transmitted from the transmitting terminal 100A (see FIG. 3). The transmitted mail M1 comprises junk mail, which the recipient regards as a nuisance, and ordinary transmitted mail other than junk mail.

The mail classification number 01 corresponds to the receive mail M2 (see FIG. 3). The receive mail M2 is an electronic mail which is sent as a reply to the transmitting terminal 101A when, after receiving the transmitted mail Ml from the receiving terminal 100B, the recipient has determined that the transmitted mail M1 is not a junk mail.

The mail classification number 02 corresponds to the reception refusal mail M3 (see FIG. 3). The reception refusal mail M3 is a mail which is sent to the electronic mail relay apparatus 400B when the transmitted mail M1 has been received at the receiving terminal 100B and the recipient has determined that the transmitted mail M1 is a junk mail, the reception refusal mail M3 notifies a provider B that the transmitted mail M1 (junk mail) has been received.

The warning request mail M4 is an electronic mail which is sent to the electronic mail relay apparatus 400A (provider A) from the electronic mail relay apparatus 400B when notification of reception refusal has been received by the reception refusal mail M3.

The warning request mail M4 when the provider B requests the provider A to warn the transmitter of the transmitted mail M1 (junk mail) that a penalty will be incurred unless he ceases transmitting. The condition which requests a warning is, for example, that one junk mail has been received.

The warning mail M5 is an electronic mail transmitted from the electronic mail relay apparatus 400A (provider A) to the transmitting terminal 100A (the transmitter of the junk mail) based on the warning request mail M4. The provider A uses the warning mail M5 to send a warning to the transmitter.

The penalty invoice request mail M6 is an electronic mail transmitted from the electronic mail relay apparatus 400B (provider B) to the electronic mail relay apparatus 400A (provider A) when the reception refusal notifications regarding the same transmitter have been received from the same recipient by sending reception refusal mails M3 more than, for example, two times.

The penalty invoice request mail M6 is used when the provider B requests the provider A to send a penalty invoice to the transmitter with regard to transmission of the transmitted mail M1 (junk mail). A condition which sends the penalty invoice is, for example, that more than two junk mails have been received on the same receiving side.

The penalty invoice mail M7 is an electronic mail sent from the electronic mail relay apparatus 400A (provider A) to the transmitting terminal 100A (transmitter of the junk mail) based on the penalty invoice request mail M6. The penalty invoice mail M7 is used in sending a penalty invoice to the transmitter of the junk mail.

The transmitting terminal 100A is a computer terminal, provided on the side of the transmitter (ABC Trading) who transmits the transmitted mail M1 (junk mail and the like), and is connected to the electronic mail relay apparatus 400A via the terminal adapter 200A, an ISDN (Integrated Service Digital Network)/IP (internet protocol) network 300.

The transmitting terminal 101A has functions of transmitting the transmitted mail M1, and receiving the warning mail M5 and penalty invoice mail M7. An IP address of abc@bbb.com is appended to the transmitting terminal 100A. Although in this embodiment the transmitting terminal 101A has the functions of both transmitting and receiving electronic mails, since it concentrates on the “transmission” of “junk mail”, the transmitting terminal 100A is termed a “transmission terminal”.

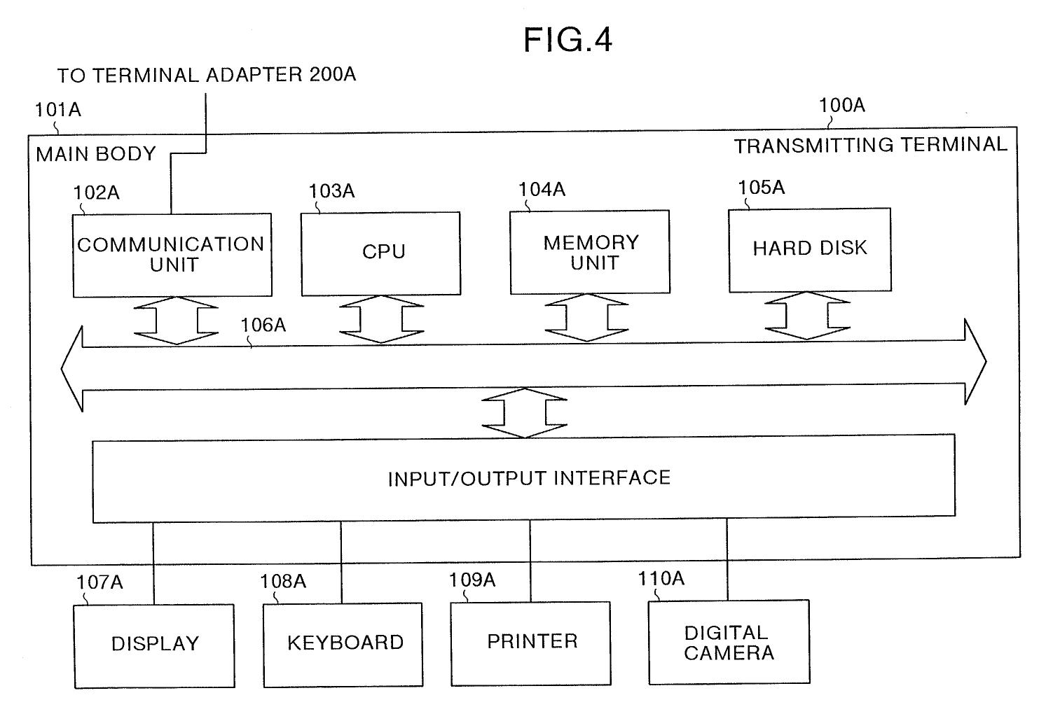

FIG. 4 is a block diagram showing the constitution of the transmitting terminal 101A shown in FIG. 1. In the transmitting terminal 100A shown in FIG. 4, a main body 101A comprises a communication unit 102A, a CPU (Central Processing Unit) 103A, a memory unit 104A, a hard disk 105A, and an input/output interface 106A.

The communication unit 102A connects to the terminal adapter 200A (see FIG. 1), and controls communication. The CPU 103A controls the creation, transmission, reception, and the like, of electronic mails, based on a mail program. The operation of the CPU 103A will be explained later.

The memory unit 104A comprises a ROM (Read Only Memory) a RAM (Random Access Memory), or the like. The hard disk 105A is a large-capacity memory unit. Mail programs and the like are stored on the hard disk 105A.

The input/output interface 106A interfaces with external devices. The input/output interface 106A is connected to a display 107A, a keyboard 108A, a printer 109A, and a digital camera 110A.

Returning to FIG. 1, the receiving terminal 100B is a computer terminal provided on the side of the recipient (Fujitsu Taro) of the transmitted mail M1, and connects via a communication device, comprising a terminal adapter 200B, and an ISDN/IP network 300 to the electronic mail relay apparatus 400B.

The receiving terminal 100B has the functions of receiving the transmitted mail M1, and transmitting the reply mail M2 and reception refusal mail M3. Furthermore, an IP address of fuji@zzz.co.jp is appended to the receiving terminal 100B. Although in this embodiment the receiving terminal 100B has both the functions of transmitting and receiving electronic mails, since it concentrates on the “transmission” of “junk mail”, the receiving terminal 100B is termed a “receiving terminal”.

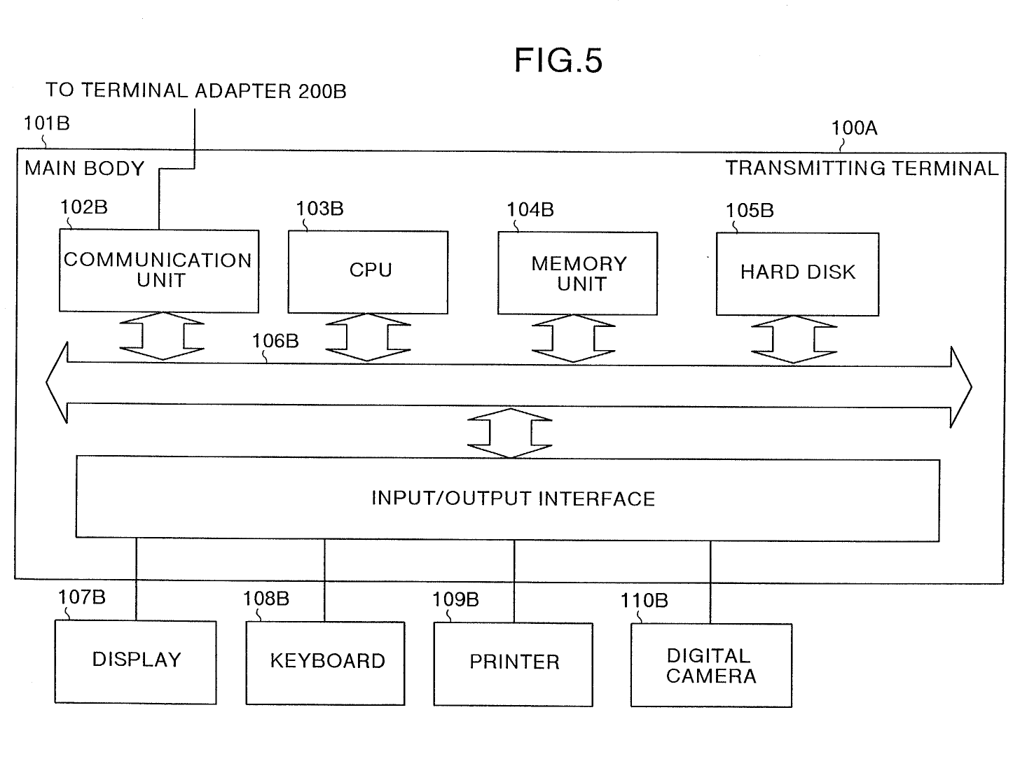

FIG. 5 is a block diagram showing the constitution of the receiving terminal 100B shown in FIG. 1. In the receiving terminal 100B shown in FIG. 5, a main body 101B comprises a communication unit 102B, a CPU (Central Processing Unit) 103B, a memory unit 104B, a hard disk 105B, and an input/output interface 106B.

The communication unit 102B connects to the terminal adapter 200B (see FIG. 1), and controls communication. The CPU 103B controls the creation, transmission, reception, and the like, of electronic mails, based on a mail program. The operation of the CPU 103B will be explained later.

The memory unit 104B comprises a ROM (Read Only Memory), a RAM (Random Access Memory), or the like. The hard disk 105B is a large-capacity memory unit. Mail programs and the like are stored on the hard disk 105B.

The input/output interface 106B interfaces with external devices. The input/output interface 106B is connected to a display 107B, a keyboard 108B, a printer 109B, and a digital camera 110B.

Returning to FIG. 1, the electronic mail relay apparatus 400A is provided at the providerA, and is inserted between the ISDN/IP network 300 and the Internet 500. The provider A is a communication company which provides an internet connection service for its members (e.g. ABC Trading).

The electronic mail relay apparatus 400A relays electronic mail (transmitted mail M1) from the ISDN/IP network 300 to the Internet 500, and relays electronic mails (warning request mail M4 and penalty invoice request mail M6) from the Internet 500 to the ISDN/IP network 300. In addition, the electronic mail relay apparatus 400A has functions such as creating the warning mail M5 and the penalty invoice mail M7, and transmitting them to the transmitting terminal 100A.

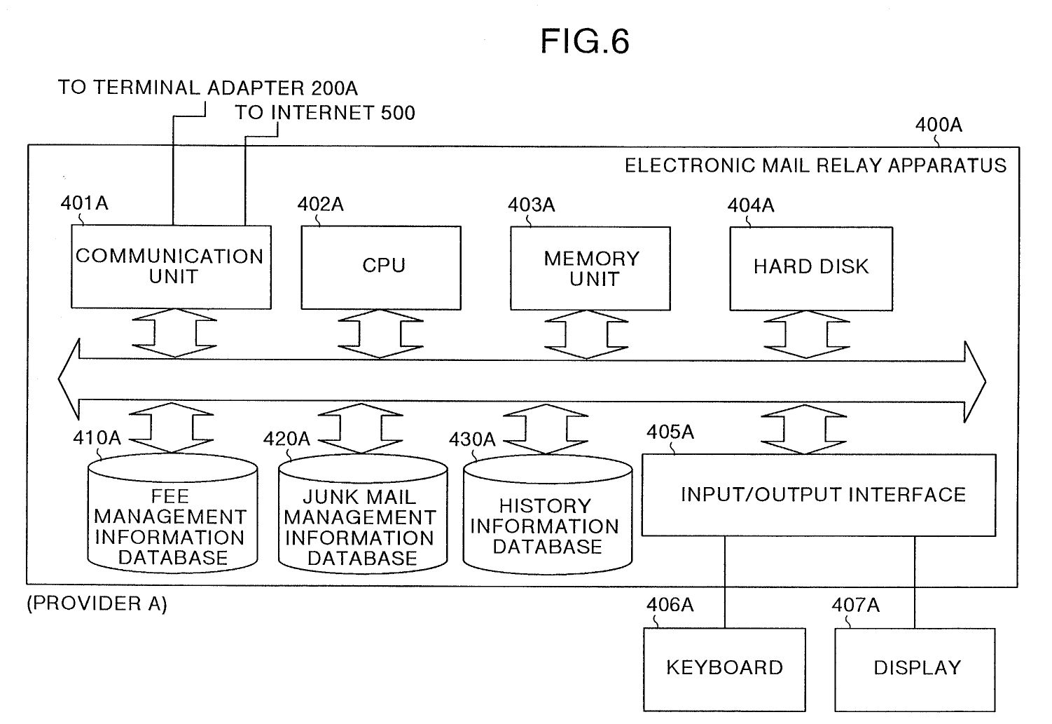

FIG. 6 is a block diagram showing the constitution of the electronic mail relay apparatus 400A shown in FIG. 1. The electronic mail relay apparatus 400A of FIG. 6 comprises a communication unit 401A, a CPU 402A, a memory unit 403A, a hard disk 404A, an input/output interface 405A, a fee management information database 410A, a junk mail management information database 420A, and a history information database 430A.

The communication unit 401A is connected to the terminal adapter 200A and the Internet 500 (see FIG. 1), and controls communication. The CPU 420A controls the relay and the like of electronic mails based on relay programs. The operation of the CPU 420A will be explained later.

The memory unit 403A comprises a ROM, a RAM, and the like. The hard disk 404A is a large-capacity memory unit. Relay programs and the like are stored on the hard disk 404A. The input/output interface 405A interfaces with external devices. The input/output interface 405A is connected to a keyboard 406A and a display 407A.

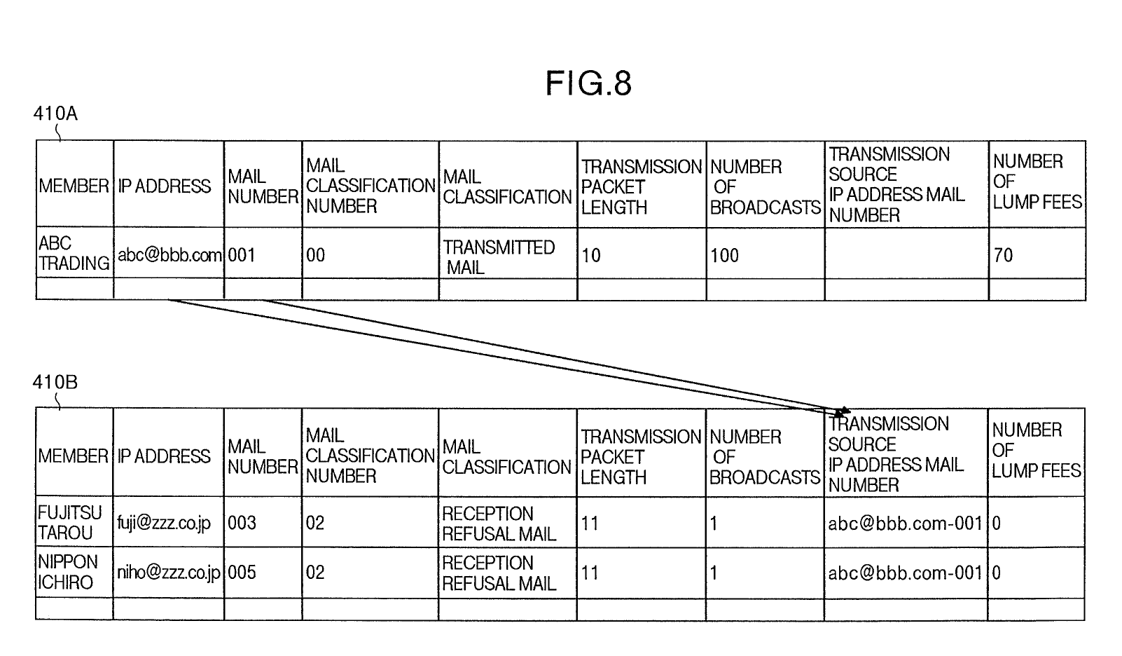

The fee management information database 410A is a database which stores fee management data to manage the fees of mail transmitting and receiving services, provided to the members by the provider A. More specifically, as shown in FIG. 8, the fee management information database 410A stores fields such as “Member”, “IP address”, “Mail Number”, “Mail Classification Number”, “Mail Classification”, Transmission Packet Length”, “Number of Broadcasts”, “Transmission Source IP Address Mail Number”, and “Number of Lump Fees”.

“Member” is information relating to names (corporate name, individual name) of the members of the provider A. “IP address” is an electronic mail address which identifies the terminal of the member. “Mail Number” is a number which identifies the electronic mail. “Mail Classification Number” corresponds to the “Mail Classification Number” shown in FIG. 3. “Mail Classification” corresponds to the “Mail Classification” shown in FIG. 3. “Transmission Packet Length” represents the length of the electronic mail packet, and is a numerical value needed to calculate the fee.

“Number of Broadcasts” is the number of broadcasts (number of destinations) when broadcasting a single transmitted mail. When the number of broadcasts is “1”, the destination of the transmitted mail is also “1”. “Transmission Source IP Address Mail Number” is information relating to the transmission source IP address and mail number when the electronic mail is a junk mail.

“Number of Lump Fees” corresponds to the number of times a single recipient has refused to receive junk mail (e.g. second time onward), and the number of invoiced lump fees. The transmitter of the junk mail is billed a lump fee comprising a fee to transmit the junk mail, a fee as the penalty mentioned above, and a fee as a charge for the warning and penalty invoice.

Ordinarily, the transmitter is billed a fee which relates only to the transmission of mail. The transmitter who has transmitted junk mail is penalized with fees relating to the penalty and charges, in addition to the fee for transmission. All or part of the penalty is fed back to the recipient of the junk mail by the electronic mail relay apparatus 400A and the electronic mail relay apparatus 400B.

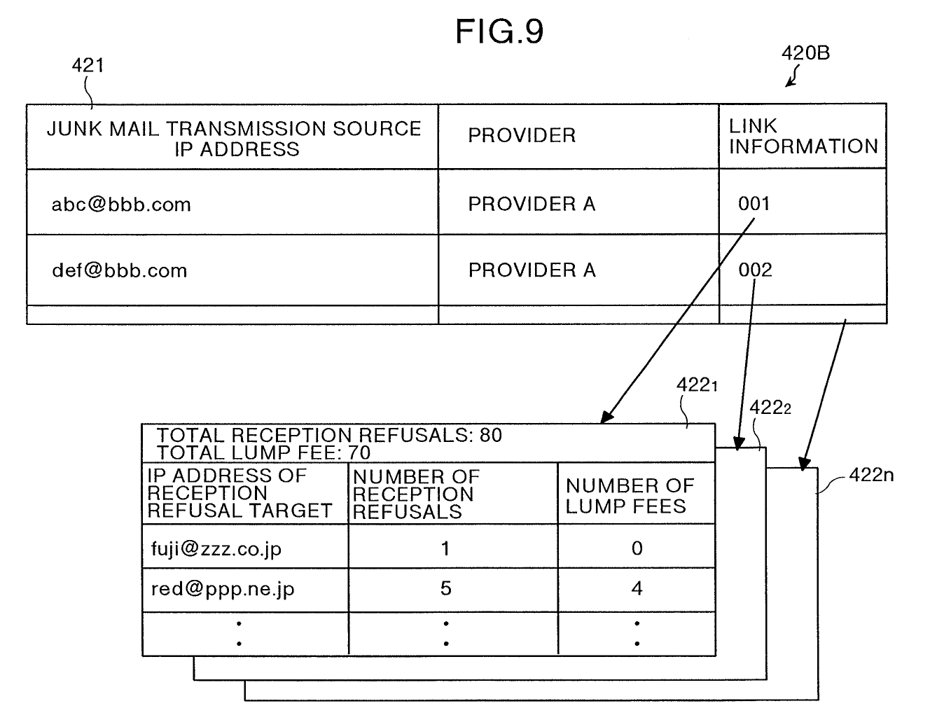

Returning to FIG. 6, the junk mail management information database 420A is a database which stores junk mail management data to manage junk mail, received by members of the provider A. The junk mail management information database 420A comprises the same table as a junk mail management information database 420B (see FIG. 9), which will be explained later. The history information database 430A is a database which stores history data to manage transmission/receive histories of members of the provider A.

Returning to FIG. 1, the electronic mail relay apparatus 400B is provided at the providerB, and is inserted between the ISDN/IP network 300 and the Internet 500. The provider B is a communication company which provides an internet connection service for its members (e.g. Fujitsu Taro).

The electronic mail relay apparatus 400B relays electronic mail (transmitted mail M1) from the Internet 500 to the ISDN/IP network 300, and relays electronic mails (receive mail M2 and reception refusal mail M3) from the ISDN/IP network 300 to the Internet 500. In addition, the electronic mail relay apparatus 400B has functions such as creating the warning request mail M4 and the penalty invoice request mail M6, and transmitting them to the electronic mail relay apparatus 400A.

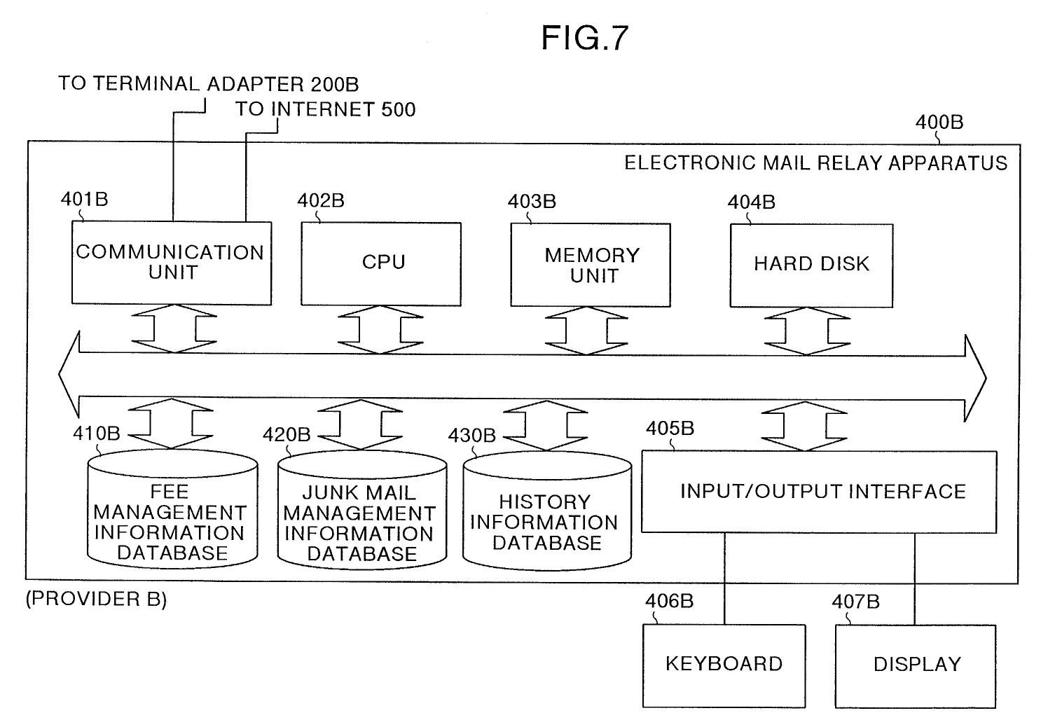

FIG. 7 is a block diagram showing the constitution of the electronic mail relay apparatus 400B shown in FIG. 1. The electronic mail relay apparatus 400B of FIG. 7 comprises a communication unit 401B, a CPU 402B, a memory unit 403B, a hard disk 404B, an input/output interface 405B, a fee management information database 410B, a junk mail management information database 420B, and a history information database 430B.

The communication unit 401B is connected to the terminal adapter 200B and the Internet 500 (see FIG. 1), and controls communication. The CPU 420B controls the relay and the like of electronic mails based on relay programs. The operation of the CPU 420B will be explained later.

The memory unit 403B comprises a ROM, a RAM, and the like. The hard disk 404B is a large-capacity memory unit. Relay programs and the like are stored on the hard disk 404B. The input/output interface 405B interfaces with external devices. The input/output interface 405B is connected to a keyboard 406B and a display 407B.

The fee management information database 410B is a database which stores fee management data to manage the fees of mail transmitting and receiving services, provided to the members by the provider B. More specifically, as shown in FIG. 8, the fee management information database 410B stores similar fields to those of the fee management information database 410A such as “Member”, “IP address”, “Mail Number”, “Mail Classification Number”, “Mail Classification”, Transmission Packet Length”, “Number of Broadcasts”, “Transmission Source IP Address Mail Number”, and “Number of Lump Fees”.

Returning to FIG. 7, the junk mail management information database 420B is a database which stores junk mail management data to manage junk mail, received by members of the provider B. As shown in FIG. 9, the junk mail management information database 420B comprises an IP address/provider information table 421, and reception refusal information tables 422₁ to 422ₙ, which are linked to each of the records in the an IP address/provider information table 421.

The IP address/provider information table 421 comprises fields such as “junk mail transmission source IP address”, “Provider”, and “Link information”. “Junk mail transmission source IP address” is the IP address of the transmission source (e.g. ABC Trading) which transmitted the junk mail, received by the member of the provider B.

“Provider” is data relating to the provider (e.g. provider A) which the transmission source (e.g. ABC Trading) belongs to. “Link information” is information relating to the link destinations of each of the records (Junk mail transmission source IP address” and “Provider”) in the IP address/provider information table 421.

The first record in the IP address/provider information table 421 is linked to the reception refusal information table 422₁. The second record in the IP address/provider information table 421 is linked to the reception refusal information table 422₂. Similarly, the nth record in the IP address/provider information table 421 is linked to the reception refusal information table 422ₙ.

The reception refusal information table 422₁ stores reception refusal information when the recipient has refused to receive a junk mail, transmitted from a junk mail transmission source IP address (abc@bbb.com) in the IP address/provider information table 421. In the reception refusal information table ⁴²²1, “IP address of a reception refusal target” is an IP address corresponding to the recipient who refused to receive the transmitted mail.

“Number of reception refusals” is the number of times reception of mails has been refused from a particular IP address. “Number of Lump Fees” is the number of lump fees of each IP address of a reception refusal target. The number of lump fees is equal to the number of reception refusals minus one. “Total reception refusals” is the total number of reception refusals. “Lump Fee Total” is the total number of lump fees.

Incidentally, FIG. 1 shows one transmission terminal 100A belonging to the provider A, but in reality multiple terminals capable of transmitting and receiving belong to the provider A. Similarly, multiple terminals capable of transmitting and receiving belong to the provider B.

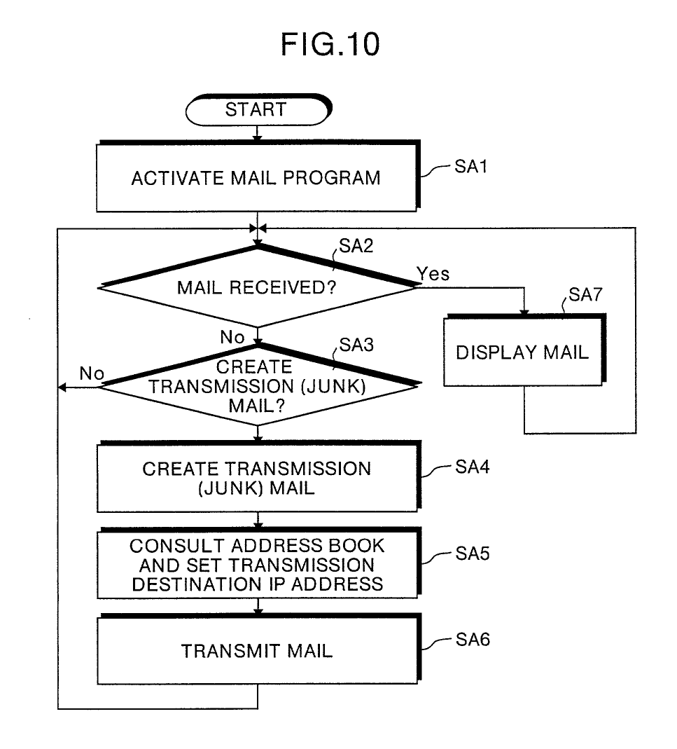

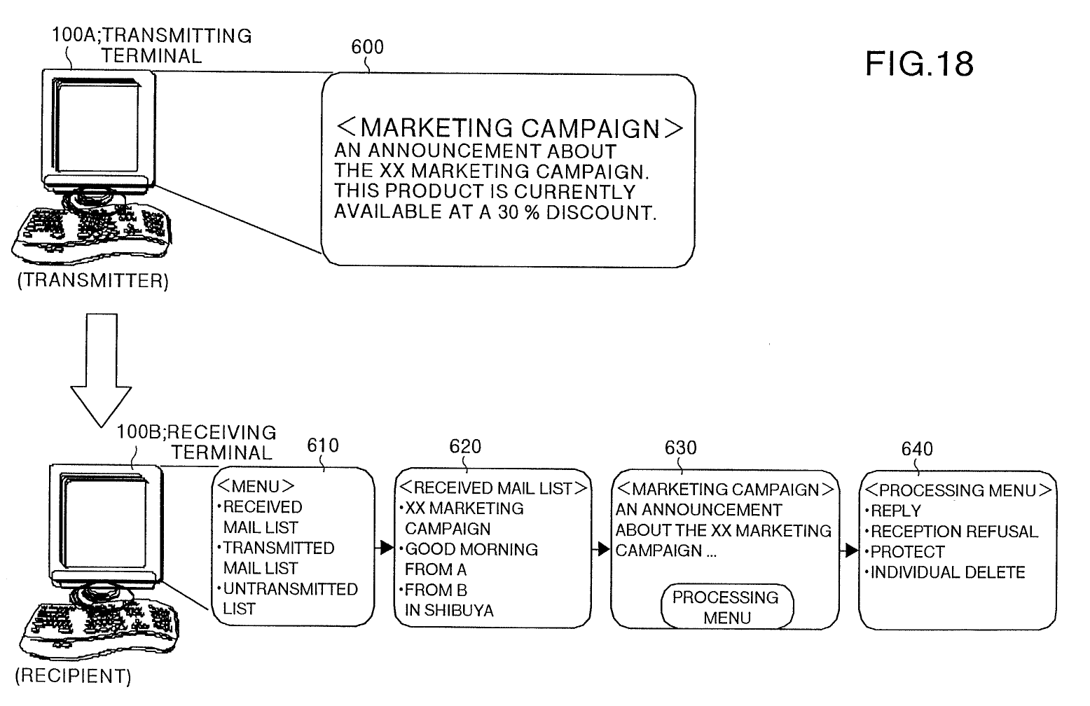

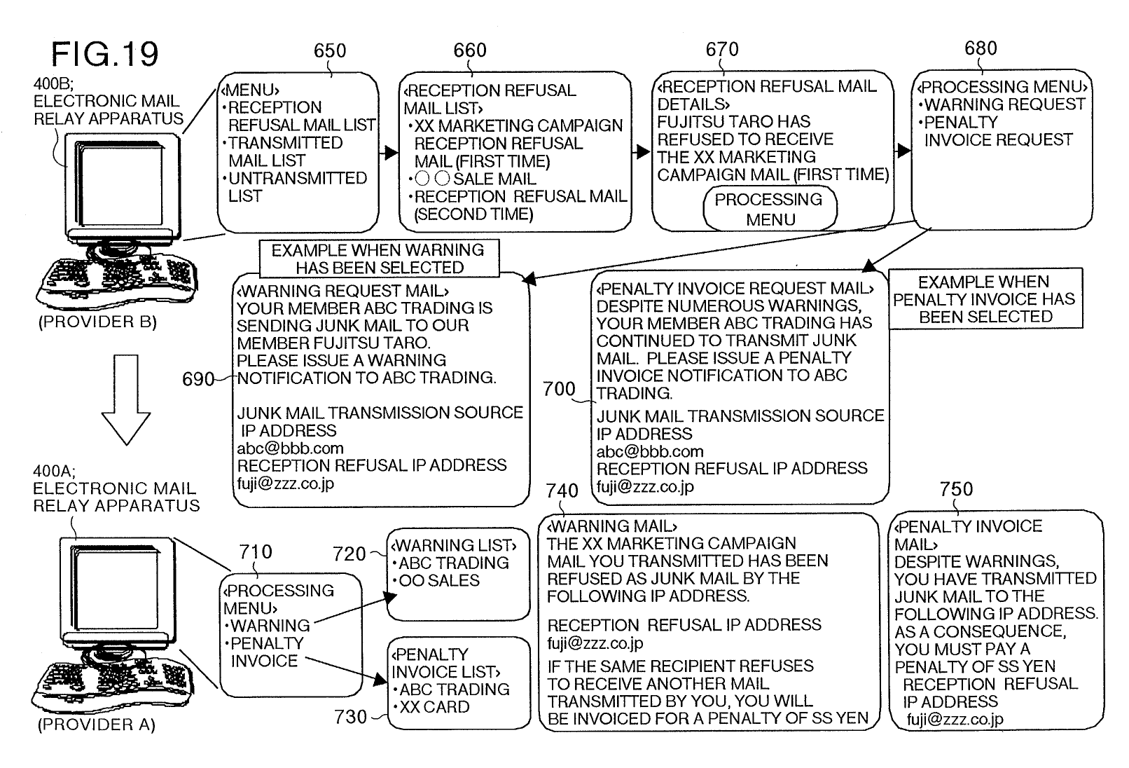

Subsequently, the operation of the embodiment will be explained with reference to the flowcharts of FIGS. 10 to 17, and the diagrams of FIGS. 18 and 19. FIG. 10 is a flowchart showing the operation of the transmission terminal 101A shown in FIG. 1.

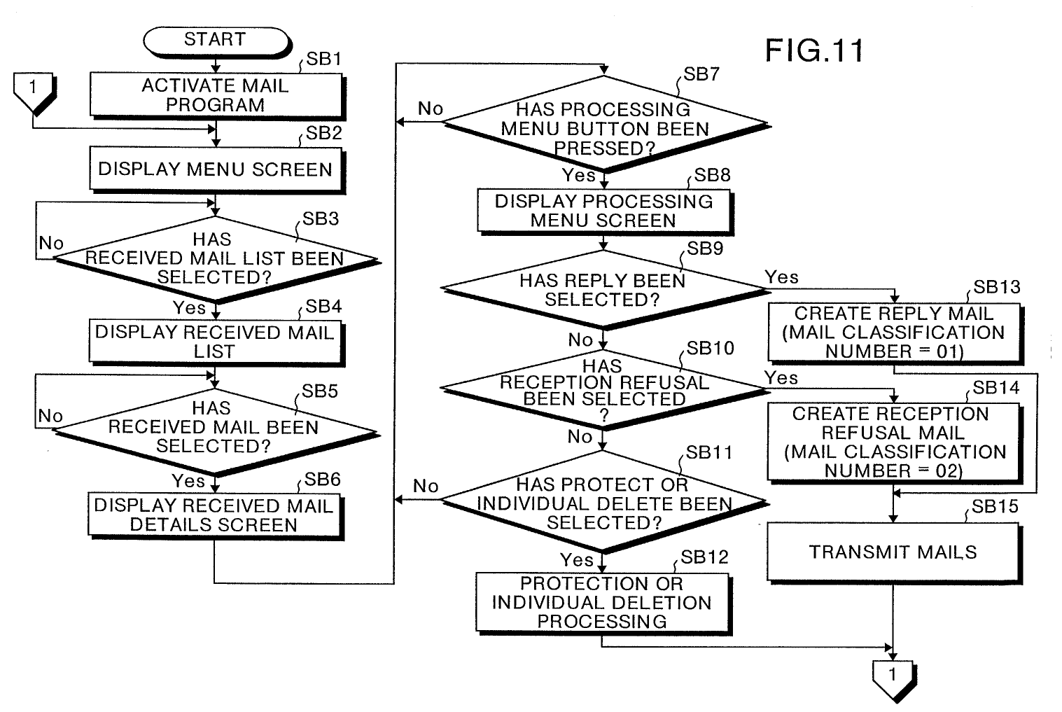

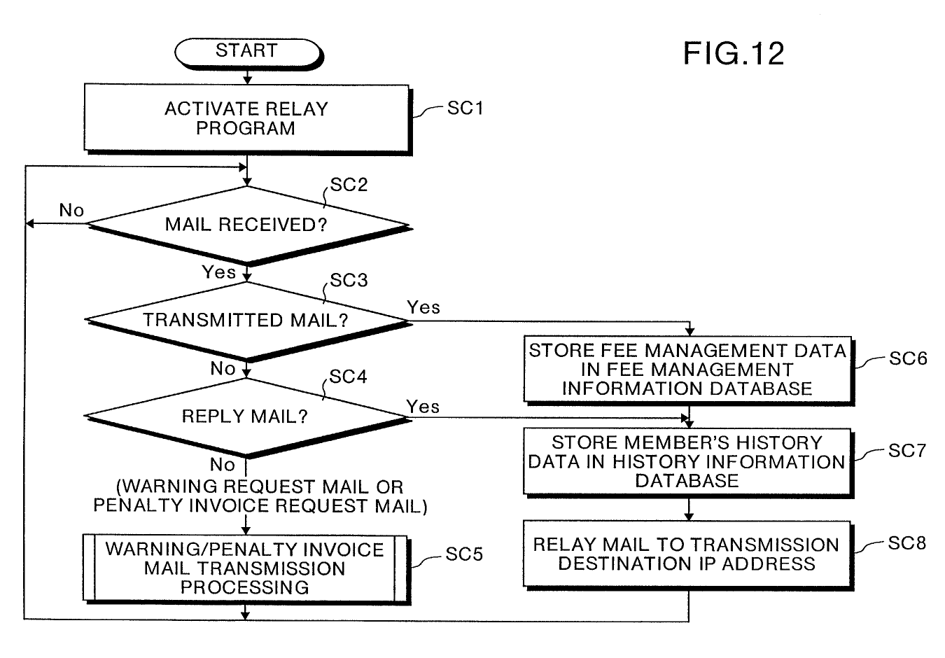

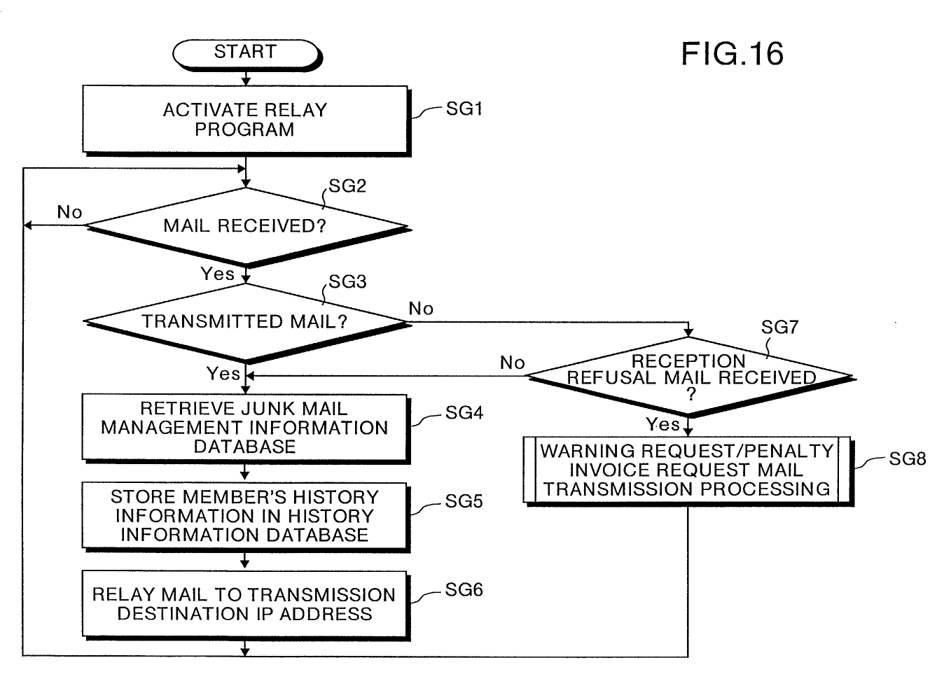

FIG. 11 is a flowchart showing the operation of the receiving terminal 100B shown in FIG. 1. FIG. 12 is a flowchart showing the operation of the electronic mail relay apparatus 400A shown in FIG. 1. FIG. 16 is a flowchart showing the operation of the electronic mail relay apparatus 400B shown in FIG. 1.

The explanation below mainly refers to when the transmitting terminal 100A shown in FIG. 1 broadcasts mass electronic mails, and one of these mails is received by the electronic mail relay apparatus 400B, which deems it a junk mail. At step SA1 of FIG. 10, the CPU 103A (see FIG. 4) of the transmitting terminal 101A activates a main program.

At step SA2, the CPU 103A determines whether the mail has been received. When the result of this determination is “Yes”, at step SA7 the CPU 103A displays the received mail at the display 107A.

When the mail has not been received, the CPU 103A determines “No” in the step SA2. At step SA3, the CPU 103A determines whether the operator of ABC Trading has issued a command to create a transmitted mail, in this case, the determined result is “No”. Thereafter, the CPU 103A repeats the determinations of steps SA2 and SA3.

At step SB1 of FIG. 11, the CPU 103B of the receiving terminal 100B (see FIG. 5) activates a mail program. At step SB2, the CPU 103B displays a menu screen 610, shown in FIG. 18.

The menu screen 610 is a screen which selects a received mail list, a transmitted mail list, or an untransmitted mail list. At step SB3, the CPU 103B determines whether the received mail list has been selected from the menu screen 610, in this case, the determined result is “No”, and the same determination is repeated.

At step SC1 shown in FIG. 12, the CPU 402A of the electronic mail relay apparatus 400A (see FIG. 6) activates a relay program. At step SC2, the CPU 402A determines whether a mail has been received, in this case, the determined result is “No”, and the same determination is repeated.

At step SG1 shown in FIG. 16, the CPU 402B of the electronic mail relay apparatus 400B (see FIG. 7) activates a relay program. At step SG2, the CPU 402B determines whether a mail has been received, in this case, the determined result is “No”, and the same determination is repeated.

When the operator of ABC Trading issues a command to create a transmitted mail, the CPU 103A determines “Yes” at step SA3. At step SA4, the CPU 103A creates the transmitted mail 600 shown in FIG. 18 based on input from the operator of ABC Trading and the format F1 (see FIG. 2).

In this case, the settings of the transmitted mail 600 are, transmission source IP address =abc@bbb.com, mail classification number=00 (transmitted mail). Furthermore, the transmitted mail 600 is a mail for a product marketing campaign, and is transmitted to a nonspecified number of terminals (including the receiving terminal 100B). Therefore, there is a high possibility that the transmitted mail will be regarded as junk mail its recipients.

At step SA5, the CPU 103A refers to an address book, and sets the transmission destination IP addresses (including the IP address of the receiving terminal 100B=fuji@zzz.co.jp) of the transmitted mail 600. At step SA6, the CPU 103A transmits (mass broadcasts) the transmitted mail 600 to the multiple transmission destination IP addresses.

Then, when the electronic mail relay apparatus 400A receives the transmitted mail 600, the CPU 402A of the electronic mail relay apparatus 400A (see FIG. 6) determines “Yes” at step SC2, shown in FIG. 12. At step SC3, CPU 402A determines whether the received mail is the transmitted mail. That is, the CPU 402A determines whether the mail classification number (see FIG. 2) of the received mail is 00, and in this case determines “Yes”.

At step SC6, the CPU 402A extracts the transmission source IP address, mail number, mail classification number, and transmission packet length information, from the transmitted mail 600 (see FIG. 2), and, based on these data, stores data representing Member, IP address, mail number, mail classification number, mail classification, transmission packet length, and number of broadcasts, in the fee management information database 410A. Member data is extracted, by using the transmission source IP address as a key, from a not-shown table which shows the relationship between transmission source IP addresses and members.

At step SC7, the CPU 402A stores history data (such as the transmission and receive times of the transmitted mail 600) of the member (ABC Trading) of the provider A in the history information database 430A. At step SC8, the CPU 402A relays the transmitted mail 600 to transmission source IP addresses (including fuji@zzz.co.jp) to the Internet 500 side.

When the transmitted mail 600 has been transmitted via the Internet 500 and received at the electronic mail relay apparatus 400B, the CPU 402B (see FIG. 7) of the electronic mail relay apparatus 400B determines “Yes” in the step SG2 shown in FIG. 16. At step SG3, the CPU 402B refers to the mail classification number (see FIG. 2) in the transmitted mail 600, and determines whether the received mail is a transmitted mail, in this case, the determined result is “Yes”.

At step SG4, based on the transmission source IP address, the CPU 402B stores the history data (such as the transmission and receive times of the transmitted mail 600) of the member (recipient, Fujitsu Taro) of the provider B in the history information database 430B.

At step SG5, the CPU 402B relays the transmitted mail 600 to the transmission source IP address (including fuji@zzz.co.jp) via the ISDN/IP network 300. Consequently, the transmitted mail 600 is transmitted to fuji@zzz.co.jp, and is received at the receiving terminal 100B via the ISDN/IP network 300 and the terminal adapter 200B.

Then, the recipient (Fujitsu Taro) selects the list of received mails from the menu screen 610 shown in FIG. 18 in order to confirm the received mail. Consequently, the CPU 103B (see FIG. 5) of the receiving terminal 100B determines “Yes” at step SB3 of FIG. 11.

At step SB4, the CPU 103B displays the received mail list screen 620 shown in FIG. 18 at the display 107B. The received mail list screen 620 displays a list of mails which have been received at the receiving terminal 100B. Here, “xx Marketing Campaign” corresponds to the transmitted mail 600.

At step SB5, the CPU 103B determines whether the received mail has been selected from the received mail list screen 620, in this example, the result is “No”, and the same determination is repeated. Then, when the recipient (Fujitsu Taro) selects “XX Marketing Campaign” from the received mail list screen 620, the CPU 103B determines “Yes” at step SB5.

At step SB6, the CPU 13B displays a received mail details screen 630, shown in FIG. 18, at the display 107B. The received mail details screen 630 shows detailed contents (details of the XX Marketing Campaign) of the transmitted mail 600 which was received by the receiving terminal 100B. Consequently, the recipient (Fujitsu Taro) can confirm the content of the transmitted mail 600.

At step SB7, the CPU 103B determines whether a process menu button of the received mail details screen 630 has been pressed, in this case, the determined result is “No” and the determination is repeated. When the recipient presses the process menu button, the CPU 103B determines “Yes” at step SB7.

At step SB8, the CPU 103B displays the process menu screen 640, shown in FIG. 18, at the display 107B. The process menu screen 640 is used in selecting a process corresponding to the received transmitted mail 600. This process may comprise “reply”, “reception refusal”, “protect”, “individual delete”, and such like. “Reply” is a process of creating a mail in reply to the transmitted mail 600, and transmitting it to the transmission source IP address (transmitter).

“Reception refusal” is a process performed when the transmitted mail 600 is a junk mail, and comprises creating and transmitting a reception refusal mail which refuses to receive the transmitted mail 600. “Protect” is a process of saving the transmitted mail 600 on the hard disk 105B and the like. “Individual delete” is a process of deleting the transmitted mail 600.

At step SB9, the CPU 103B determines whether “reply” has been selected in the process menu screen 640, in this case, “No” is determined. At step SB10, the CPU 103B determines whether “reception refusal” has been selected from the process menu screen 640, in this case, the determined result is “No”.

At step SB11, the CPU 103B determines whether “protect” or “individual delete” has been selected from the process menu screen 640, in this case, “No” is the result of this determination. Thereafter, the CPU 103B repeats the determinations of steps SB9 to SB11. Incidentally, when “Yes” is determined at step SB11, at step SB12 the CPU 103B executes a process of either protecting or individual deleting.

When the recipient has determined that the transmitted mail 600 is a junk mail, he selects “reception refusal” from the process menu screen 640. As a consequence, the CPU 103B determines “Yes” at step SB10. At step SB14, the CPU 103B creates a reception refusal mail M3 (see FIG. 1) based on the format F1 (see FIG. 2).

In this case, the settings of the reception refusal mail M3 are, transmission source IP address=fuji@zzz.co.jp, transmission destination IP address abc@bbb.com, and mail classification number=02 (reception refusal mail). At step SB15, the CPU 103B transmits the reception refusal mail M3, created at step SB14.

Then, the reception refusal mail M3 is received via the terminal adapter 200B and the ISDN/IP network 300 by the electronic mail relay apparatus 400B. Consequently, the CPU 402B of the electronic mail relay apparatus 400B determines “No” at step SG3.

At step SG7, based on the mail classification number (see FIG. 2) of the reception refusal mail M3 which was received at the electronic mail relay apparatus 400B, the CPU 402B determines whether the reception refusal mail M3 is a reception refusal mail, in this case, the determined result is, “Yes”.

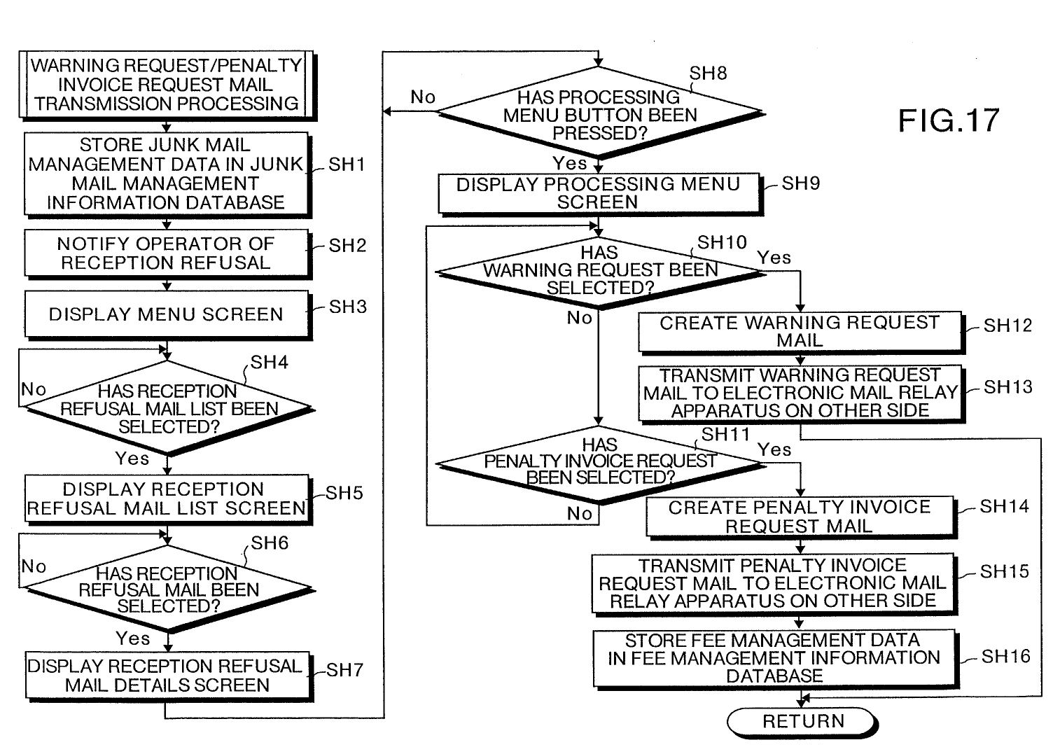

At step SG8, the CPU 402B executes warning request/penalty invoice request mail transmission processing. Specifically, at step SH1 shown in FIG. 17, the CPU 402B stores junk mail management data corresponding to the reception refusal mail M3 from the receiving terminal 100B in the junk mail management information database 420B shown in FIG. 9.

In this case, in the first record of the IP address/provider information table 421, “abc@bbb.com” is stored in the junk mail transmission source IP address, and “provider A” is stored in the provider. This provider information is extracted from a not-shown IP address/provider table which shows IP addresses in correspondence with the providers.

Furthermore, in the reception refusal information table 422₁ corresponding to the first record, the number of reception refusals for fuji@zzz.co.jp (corresponding to FujitsuTaro) is “1”. Since the number of reception refusals is “1”, the number of lump fees is “0”.

At step SH2, the CPU 402B notifies the operator of the electronic mail relay apparatus 400B of the reception refusal. At step SH3, the CPU 402B displays the menu screen 650, shown in FIG. 19, at the display 407B. At step SH4, the CPU 402B determines whether the reception refusal mail list has been selected from the menu screen 650, in this case, the determined result is “No”, and the determination is repeated.

Then, when the operator selects the reception refusal mail list, the CPU 402B determines “Yes” at step SH4. At step SH5, the CPU 402B displays the reception refusal mail list screen 660, shown in FIG. 19, at the display 407B. The reception refusal mail list screen 660 shows a list of reception refusal mails, received by the electronic mail relay apparatus 400B.

At step SH6, the CPU 402B determines whether the reception refusal mail has been selected from the reception refusal mail list screen 660, in this case, a result of “No” is determined, and the determination is repeated. When the operator selects the “XX Marketing Campaign” reception refusal mail (first refusal), the CPU 402B determines “Yes” at step SH6.

At step SH7, the CPU 402B displays a reception refusal mail details screen 670 corresponding to “XX Marketing Campaign” at the display 407B. The fact that the member (Fujitsu Taro) of the provider B has refused to receive the “XX Marketing Campaign Mail” (transmitted mail 600, see FIG. 18), and the number of reception refusals (first refusal) are displayed at the display 407B.

At step SH8, the CPU 402B determines whether a processing menu button of the reception refusal mail details screen 670 has been pressed, in this case, the determined result is “No”, and the determination is repeated. When the operator presses the processing menu button, the CPU 402B determines “Yes” at step SH8. At step SH9, the CPU 402B displays the processing menu screen 680, shown in FIG. 19, at the display 407B.

The processing menu screen 680 is a screen which selects the processes of requesting a warning or requesting a penalty invoice. The warning request processing is executed when a single recipient has received to refuse a junk mail for the first time, and comprises creating and transmitting a warning request mail 690 from the provider B to the provider shown in FIG. 9 (in this case, provider A), in order to warn the member (ABC Trading) who transmitted the transmitted mail 600 (junk mail).

The warning request mail 690 comprises a warning request text, a junk mail transmission source IP address, and a IP address of a reception refusal target.

On the other hand, the penalty invoice request processing in the processing menu screen 680 is executed when a single recipient has received to refuse a junk mail for the second time or more, and comprises creating and transmitting a penalty invoice request mail 700 from the provider B to the provider shown in FIG. 9 (in this case, provider A), in order to request a penalty invoice against the member (ABC Trading) The penalty invoice request mail 700 comprises a penalty invoice request text, a junk mail transmission source IP address, and a IP address of a reception refusal target.

Returning to FIG. 17, at step SH10, the CPU 402B determines whether a warning request has been selected in the processing menu screen 680, in this case, the determined result is, “No”. At step SH11, the CPU 402B determines whether a penalty invoice request has been selected in the processing menu screen 680, in this case, the determined result is, “No”. Thereafter, the CPU 402B repeats the determinations of steps SH10 and SH11.

Then, when the operator selects a warning request, the CPU 402B determines “Yes” at step SH10. At step SH12, the CPU 402B creates a warning request mail 690. At step SH13, the CPU 402B relays the warning request mail 690 via the Internet 500 to the electronic mail relay apparatus 400A.

When the electronic mail relay apparatus 400A receives the warning request mail 690, the CPU 402A of the electronic mail relay apparatus 400A determines “Yes” at step SC1 shown in FIG. 12. At step SC3, the CPU 402A determines whether the received warning request mail 690 is a transmitted mail (mail classification number=00) from a member, and in this case the determined result is “No”.

At step SC4, the CPU 402A determines whether the received warning request mail 690 is a reply mail (mail classification number=01) from a member, in this case, the determined result is “No”. At step SC5, the CPU 402A executes warning/penalty invoice mail transmission processing.

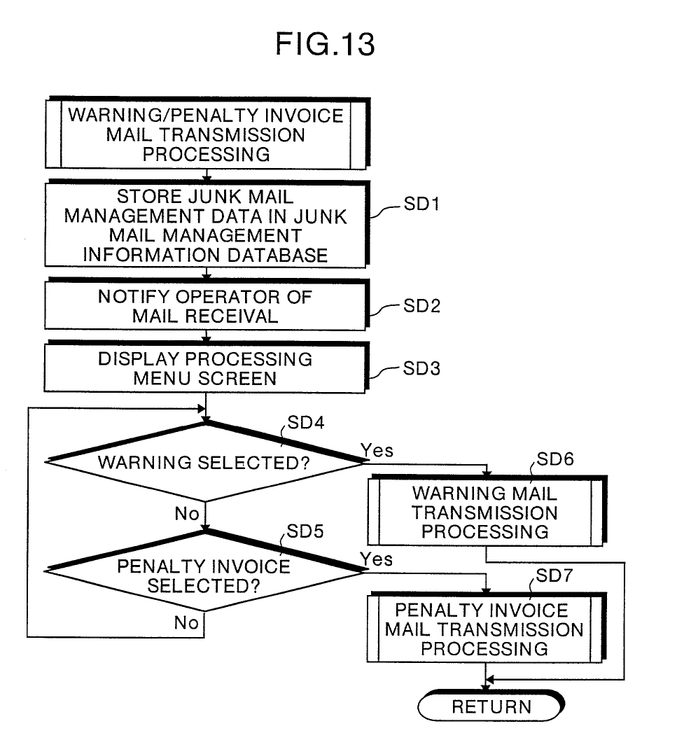

More specifically, at step SD1 shown in FIG. 13, the CPU 402A stores junk mail management data, corresponding to the warning request mail 690, in the junk mail management information database 420A (see FIG. 1). At step SD2, the CPU 402A notifies the operator of the electronic mail relay apparatus 400A that the mail has been received. At step SD3, the CPU 402A displays the processing menu screen 710 shown in FIG. 19 at the display 407A shown in FIG. 6.

The processing menu screen 710 is a screen which selects processing to transmit a warning, or a penalty invoice, to the member who transmitted the junk mail. Warning processing is to create and transmit a warning mail 740 from the provider A to the member (e.g. ABC Trading) based on the warning request mail 690.

The warning mail 740 comprises a warning text, and a IP address of a reception refusal target. The warning text warns the transmitter (ABC Trading) of the junk mail that he must not transmit junk mail to the recipient (Fujitsu Taro), and that he will incur a penalty invoice if he transmits another junk mail which is subsequently refused by the recipient.

Penalty invoice processing in the processing menu screen 710 is executed when a single recipient has refused to receive junk mail two times or more, and comprises creating and transmitting a penalty invoice mail 750 from the provider A to the member (e.g. ABC Trading) based on the penalty invoice request mail 700. The penalty invoice mail 750 comprises a penalty invoice text and a IP address of a reception refusal target.

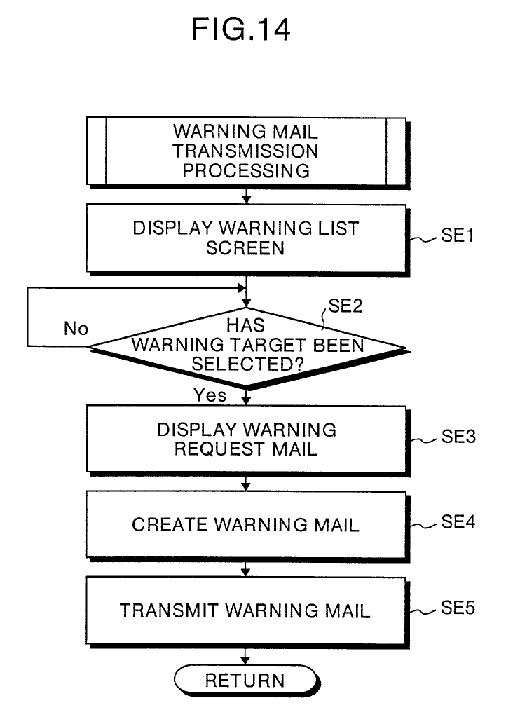

When a warning is selected in the processing menu screen 710, the CPU 402A determines “Yes” at step SD4 shown in FIG. 13. At step SD6, the CPU 402A executes warning mail transmission processing. Specifically, at step SE1 shown in FIG. 14, the CPU 402A displays a warning list screen 720, shown in FIG. 19, at the display 407A.

At step SE2, the CPU 402A determines whether a warning target has been selected from the warning list screen 720, in this case the determined result is “No”, and the determination is repeated. When ABC Trading is selected in the warning list screen 720, the CPU 402A determines “Yes” at step SE2.

At step SE3, the CPU 402A displays the warning request mail 690, which was received earlier, at the display 407A. At step SE4, the CPU 402A creates the warning mail 740. At step SE5, the CPU 402A transmits the warning mail 740 to the transmitting terminal 100A (ABC Trading).

When the warning mail 740 is received at the transmitting terminal 100A, ABC Trading is warned that fuji@zzz.co.jp, corresponding to Fujitsu Taro, has refused to receive the transmitted mail 600 after deeming it a junk mail. Consequently, ABC Trading deletes fuji@zzz.co.jp from the address book, and transmits no further transmitting mails to fuji@zzz.co.jp.

In this example, it is assumed that ABC Trading is an unscrupulous agency who ignores the warning and transmits another mail to fuji@zzz.co.jp. As a consequence, by the operation already described, Fujitsu Taro deems the transmitted mail to be a second junk mail. In this case, the receiving terminal 100B transmits a second reception refusal mail M3 to the electronic mail relay apparatus 400B.

Then, when the electronic mail relay apparatus 400B receives the reception refusal mail M3, at step SH9 shown in FIG. 17, the CPU 402B displays the processing menu screen 680 (see FIG. 19) relating to the second reception refusal mail M3 at the display 407B via the operation already mentioned above.

In this case, since this is the second junk mail from an unscrupulous agency, the operator selects penalty invoice from the processing menu screen 680. Consequently, the CPU 402B determines “Yes” at step SH11. At step SH14, the CPU 402B creates the penalty invoice request mail 700.

At step SH15, the CPU 402B transmits the penalty invoice request mail 700 via the Internet 500 to the electronic mail relay apparatus 400A. At step SH16, the CPU 402B stores the fee management data in the fee management information database 410B shown in FIG. 8.

When the penalty invoice request mail 700 is received at the electronic mail relay apparatus 400A, the CPU 402A of the electronic mail relay apparatus 400A determines “Yes” at step SC2 shown in FIG. 12. At step SC3, the CPU 402A determines whether the received penalty invoice request mail 700 is a transmitted mail from a member, in this case, the determined result is, “No”.

At step SC4, the CPU 402A determines whether the received penalty invoice request mail 700 is a reply mail from a member, in this case, the determined result is “No”. At step SC5, the CPU 402A executes warning/penalty invoice mail transmission processing.

More specifically, at step SD1 shown in FIG. 13, the CPU 402A stores junk mail management data, corresponding to the penalty invoice request mail 700, in the junk mail management information database 420A (see FIG. 1). At step SD2, the CPU 402A notifies the operator of the electronic mail relay apparatus 400A that the mail has been received. At step SD3, the CPU 402A displays the processing menu screen 710, shown in FIG. 19, at the display 407A.

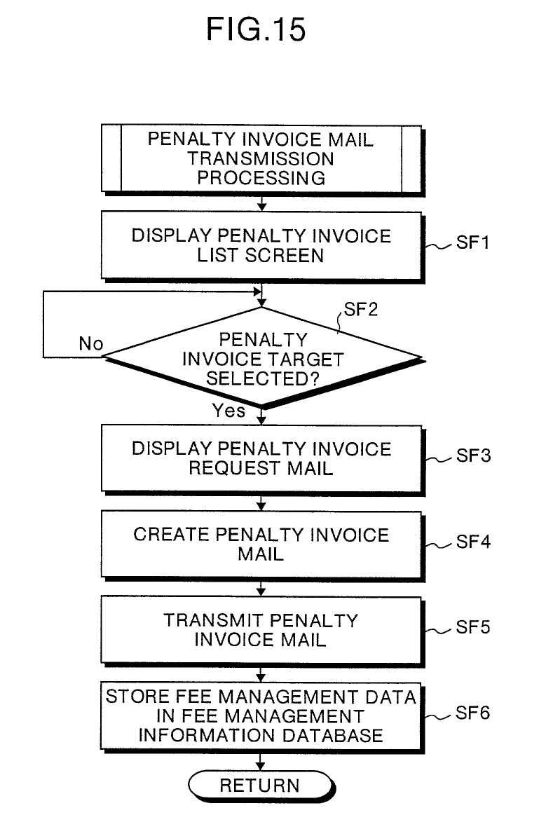

When the penalty invoice is selected in the processing menu screen 710, the CPU 402A determines “No” at step SD4 shown in FIG. 13, and determines “Yes” at step SD5. At step SD7, the CPU 402A executes penalty invoice mail transmission processing. More specifically, at step SF1 shown in FIG. 15, the CPU 402A displays the penalty invoice list screen 730, shown in FIG. 19, at the display 407A.

At step SF2, the CPU 402A determines whether a penalty invoice target has been selected from the penalty invoice list screen 730, in this case, the CPU 402A determines “No” and repeats the determination. When ABC Trading is selected from the penalty invoice list screen 730, the CPU 402A determines “Yes” at step SF2.

At step SF3, the CPU 402A displays the penalty invoice request mail 700, received earlier, at the display 407A. At step SF4, the CPU 402A creates the penalty invoice mail 750. At step SF5, the CPU 402A transmits the penalty invoice mail 750 to the transmitting terminal 100A (ABC Trading). At step SF6, the CPU 402A stores the fee management data in the fee management information database 410A.

Then, when the penalty invoice mail 750 is received by the transmitting terminal 100A, ABC Trading realizes that a penalty has been invoiced in relation to junk mail transmitted to fuji@zzz.co.jp.

The amount of the penalty invoice to ABC Trading is determined by multiplying the number of the junk mail penalty invoice by a penalty unit price (SS Yen). The penalty invoice amount is used as profit for the provider A, which the transmitter (ABC Trading) of the junk mail belongs to, and as feedback money to the recipient of the junk mail (Fujitsu Taro). The feedback money may be fed back by, for example, offering a discount from fees which the recipient was supposed to pay to the provider, or by direct money transfer to an account of the recipient at a financial center.

Incidentally, when the transmitted mail 600 is not a junk mail, the recipient (Fujitsu Taro) at the receiving terminal 100B selects “reply” in the processing menu screen 640 shown in FIG. 18. Consequently, the CPU 103B of the receiving terminal 100B determines “Yes” at step SB9 shown in FIG. 11.

At step SB13, based on commands input by the recipient, the CPU 103B creates a reply mail M2 comprising a mail classification number of “01” and a transmission destination IP address of “abc@bbb.com”. At step SB15, the CPU 103B transmits the receive mail M2 to abc@bbb.com.

When the receive mail M2 is received at the electronic mail relay apparatus 400B, the CPU 402B of the electronic mail relay apparatus 400B determines “No” in the step SG3, shown in FIG. 16. At step SG6, the CPU 402B determines “No”.

At step SG4, the CPU 402B stores history data of the member (Fujitsu Taro) in the history information database 430B (see FIG. 7). At step SG5, the CPU 402B transmits the receive mail M2 to the transmission destination IP address (abc@bbb.com)

When the receive mail M2 is received via the Internet 500 by the electronic mail relay apparatus 400A, the CPU 402A of the electronic mail relay apparatus 400A determines “Yes” at step SC2, shown in FIG. 12. At step SC3, the CPU 402A determines “No”.

At step SC4, the CPU 402A determines “Yes”. At step SC7, the CPU 402A stores history data of the member (ABC Trading) in the history information database 430A (see FIG. 5). At step SC8, the CPU 402A relays the receive mail M2 to the transmission destination IP address.

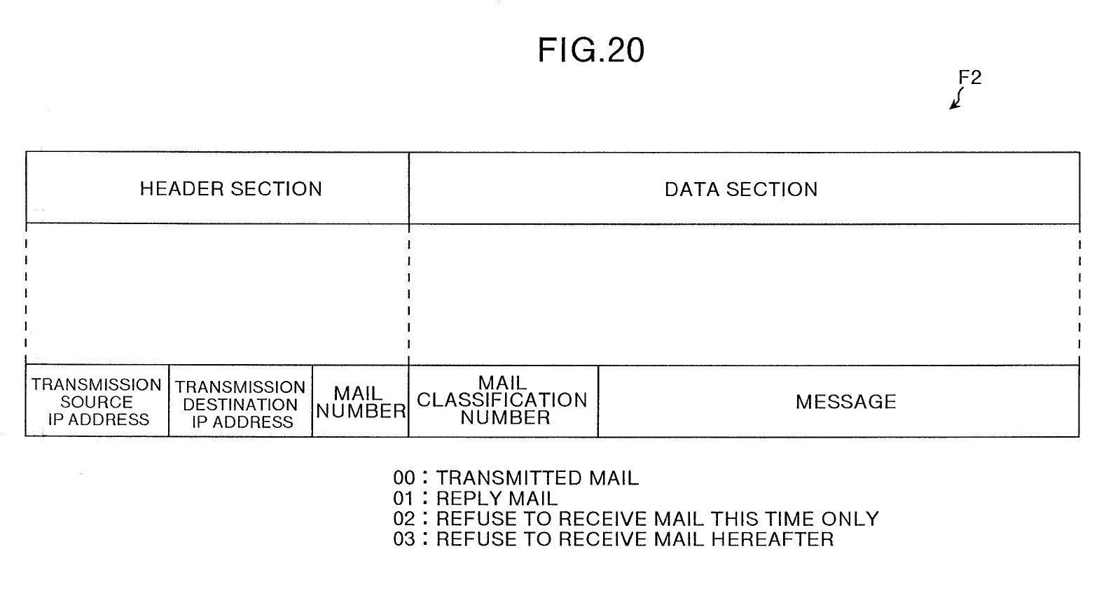

Incidentally, in the embodiment described above, the recipient of the junk mail may select “reception refusal this time only” or “reception refusal hereafter”. In this case, the format F1 shown in FIG. 2 is replaced by a format F2 shown in FIG. 20.

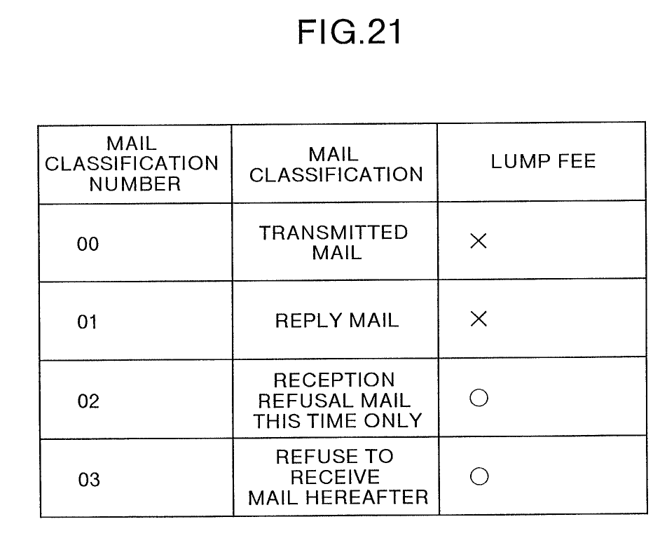

In the format F2, the mail classification numbers 02 “this time reception refusal mail” and 03 “reception refusal hereafter mail”, shown in FIG. 21, are used instead of the mail classification number 02 “reception refusal mail”, shown in FIG. 3.

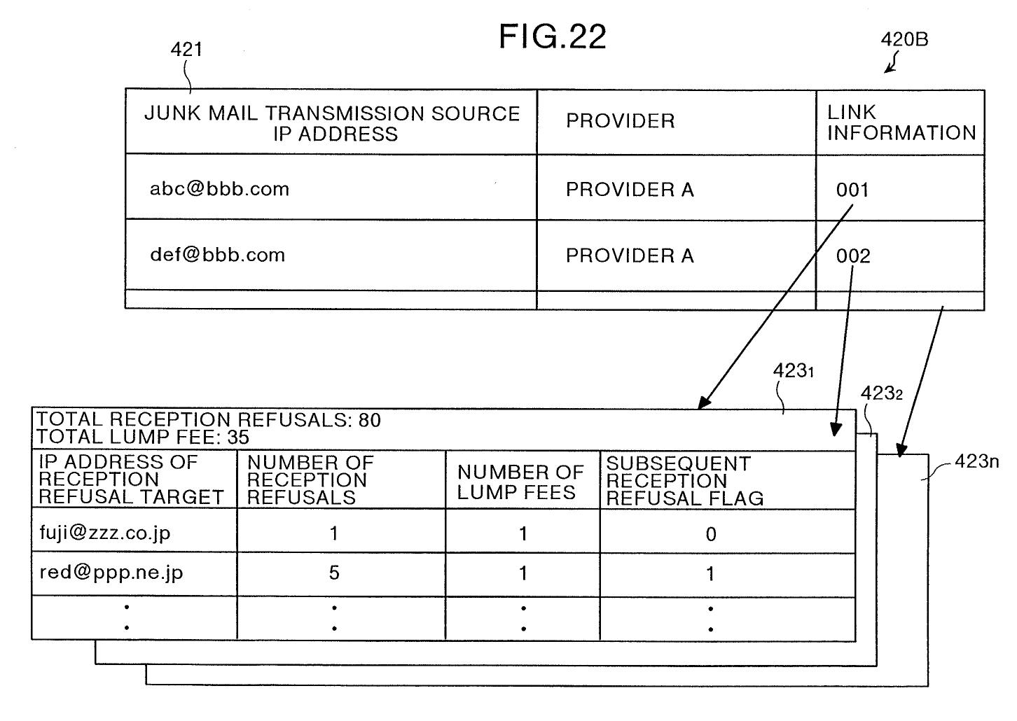

Moreover, when allowing “reception refusal this time only” and “reception refusal hereafter” to be selected, a junk mail management information database 420B, shown in FIG. 22, is used instead of the junk mail management information database 420B, shown in FIG. 9.

In the reception refusal information tables 423₁ to 423ₙ shown in FIG. 22, a “reception refusal hereafter flag” is set. This reception refusal hereafter flag is set at “1” when a reception refusal mail M3 (see FIG. 1) with a mail classification number of 03 (see FIG. 20) is received at the electronic mail relay apparatus 400B.

In this case, when a transmitted mail M1 (see FIG. 1) comprising a junk mail is transmitted to the same recipient for more than a second time, the CPU 402B of the electronic mail relay apparatus 400B does not relay the transmitted mail M1 to the recipient whose reception refusal hereafter flag is at “1”. As a consequence, the junk mail is prevented from being sent to the recipient more than a second time.

As described above, according to this embodiment, when a recipient (Fujitsu Taro) has determined that a transmitted mail 600 (see FIG. 18) is a junk mail, a warning mail 740 (see FIG. 19) is transmitted to the transmitter, and, following notification of the warning, if that there is a second reception refusal notification from the receiving terminal 100B, a penalty invoice mail 750 is transmitted to the transmitter. Therefore, the retransmission of junk mail from an agency to an advertising target can be prevented.

Moreover, since the penalty which is paid by the transmitter is fed back to the recipient, the recipient can be financially compensated for the nuisance he incurred in receiving the junk mail, thereby increasing his trust in the reliability of the mail service.

Furthermore, since an amount equivalent to the penalty is deducted from fees to be paid by the recipient, the recipient can be given a sense of profit, further increasing his trust in the reliability of the mail service.

Moreover, when the mail classification number is set at 03 (reception refusal hereafter mail) in the format F2 shown in FIG. 20, and a mail is transmitted from the transmitting terminal 100A to the receiving terminal 100B, the electronic mail relay apparatus 400B terminates the relay of the transmitted mail, avoiding the unnecessary time and cost of receiving the junk mail.

An embodiment of the invention has been described above with reference to the drawings, but the specific constitution is not limited to that described in the above embodiment, and various modifications may be made without deviating from the essential idea of the invention.

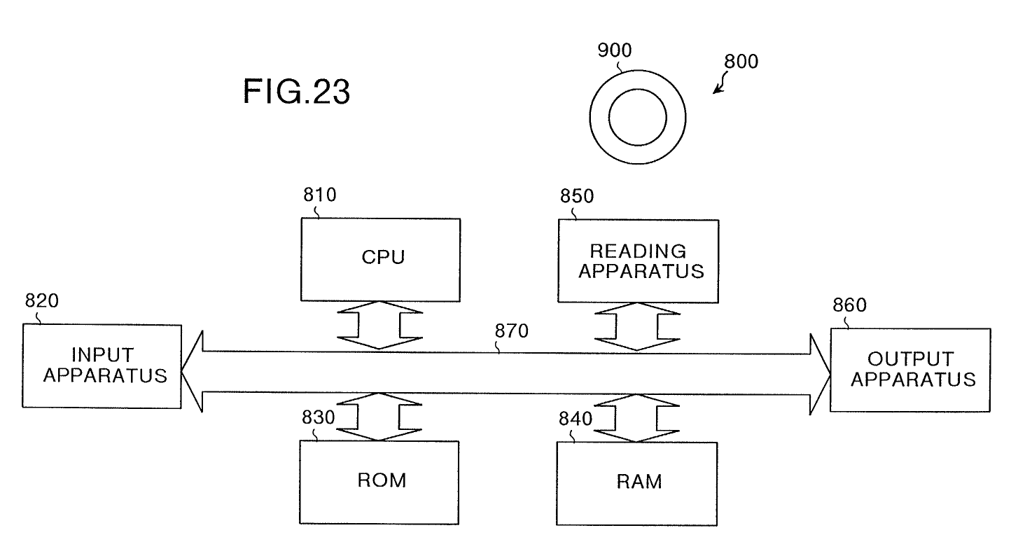

For example, in the embodiment described above, computer programs which realize the functions of the electronic mail relay apparatus 400A, the electronic mail relay apparatus 400B, the transmitting terminal 100A, and the receiving terminal 100B, can be recorded in a computer-readable recording medium 900, shown in FIG. 23, and a computer 800 may be made to read the programs stored in the recording medium 900 and executes those computer programs.

The computer 800 comprises a CPU 810 which executes the programs, an input apparatus 820 such as a keyboard and a mouse, a ROM 830 which stores various types of data, a RAM 840 which stores calculation parameters and the like, a reading apparatus 850 which reads the programs from the recording medium 900, an output apparatus 860 such as a display and a printer, and a bus 870 which connects the various apparatuses.

Using the reading apparatus 850, the CPU 810 reads the program which is stored in the recording medium 900, and executes the program to realize the functions thereof. Incidentally, the recording medium 900 may comprise a portable recording medium such as an optical disk, a floppy disk, and a hard disk, or a transmitting medium which stores data momentarily in the manner of a network.

In the above embodiment, the functions of the electronic mail relay apparatus 400A and the electronic mail relay apparatus 400B may be realized by a single electronic mail relay apparatus.

As described above, according to this invention, when a recipient has determined that a transmitted mail is a junk mail, a warning mail is transmitted to the transmitter, and, following notification of the warning, if that there is a second reception refusal notification from the receiving terminal, a penalty invoice mail is transmitted to the transmitter. Therefore, retransmission of junk mail from agencies to advertising targets can be prevented.

Moreover, the penalty which is paid by the transmitter is fed back to the recipient. Therefore, the recipient can be financially compensated for the nuisance he incurred by receiving the junk mail, increasing his trust in the reliability of the mail service.

Furthermore, an amount equivalent to the penalty is deducted from fees to be paid by the recipient. Therefore, the recipient can be given a sense of profit, further increasing his trust in the reliability of the mail service.

Moreover, following the reception refusal notification, when a mail is transmitted from the same transmitting terminal to the same receiving terminal, the relay of the transmitted mail is terminated, thereby avoiding the unnecessary time and cost of receiving the junk mail.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of preventing transmission of junk mail, the method comprising:
relaying an electronic mail from a transmitter to a recipient;
sending a warning notice to the transmitter, when the recipient determines that the received electronic mail is a junk mail and sends a reception refusal notice; and
issuing a penalty invoice notice to the transmitter, when the recipient sends the reception refusal notice for a particular number of times with respect to the same transmitter.

2. The method according to claim 1, further comprising executing fee processing of feeding back a penalty fee collected from the transmitter to the recipient.

3. The method according to claim 2, wherein an amount equal to penalty fee feed back to the recipient is deducted from the charges the recipient is required to pay for maintaining the mail account.

4. The method according to claim 1, wherein if the transmitter sends the reception refusal notice for another particular number of times to the same transmitter, relaying of electronic mail from the transmitter to the recipient is stopped.

5. The method according to claim 1, wherein the warning notice is issued after the recipient sends the reception refusal notification first time, and the particular number of times is equal to two.

6. An electronic mail relay apparatus comprising:
a relay unit which relays an electronic mail from an electronic mail address of a transmitter to an electronic mail address of a receiver;
a warning notice unit which sends a warning notice to the transmitter, when the recipient determines that the received electronic mail is a junk mail and sends a reception refusal notice; and
a penalty invoice notification unit which issues a penalty invoice notice with respect to the electronic address of the transmitter, when the recipient sends the reception refusal notice for a particular number of times with respect to the same transmitter.

7. A computer program containing instructions which when executed on a computer causes the computer to realize the functions of:
a relay unit which relays an electronic mail from an electronic mail address of a transmitter to an electronic mail address of a receiver;
a warning notice unit which sends a warning notice to the transmitter, when the recipient determines that the received electronic mail is a junk mail and sends a reception refusal notice; and
a penalty invoice notification unit which issues a penalty invoice notice with respect to the electronic address of the transmitter, when the recipient sends the reception refusal notice for a particular number of times with respect to the same transmitter.

8. A method of preventing transmission of junk mail, the method comprising:
relaying an electronic mail from a transmitter to a recipient;
the recipient determining whether the received electronic mail is a junk mail or not, and sending a reception refusal notice when determining that the received electronic mail is a junk mail;
sending a warning notice to the transmitter if the recipient sends the reception refusal notice for a first time; and
issuing a penalty invoice notice to the transmitter if the recipient sends the reception refusal notice for a particular number of times.
